(19) United States
(12) Patent Application Publication
(10) Pub. No.: US 2002/0179644 A1
(43) Pub. Date: Dec. 5, 2002

(54) Toggle action dispensing closure with locking means

(76) Inventors: Christopher T. Evans, Long Valley, NJ (US); Kenneth R. Jones, Wayne, NJ (US)

Correspondence Address: Peter J Cronk, Duane Morris, One Liberty Place, Philadelphia, PA, 19103-7396, US

(21) Appl. No.: 10/148,738

(22) PCT Filed: Dec. 1, 2000
(86) PCT No.: PCT/US00/32653

(51) Int. Cl. B67B 5/00

(52) U.S. Cl. 222/153.14; 222/534; 222/536

(57) ABSTRACT

A toggle action dispensing closure has a locking mechanism which prevents the closure from being actuated to an open position. This closure includes a base, a lid and a movable lug. The lid is movably mounted to the base. The lug is attached to the lid and engages the base to prevent the lid from being toggled from a closed position to an open position. The lid is moved to an open position by displacing the movable lug to an actuating position.

This application claims the benefit of U.S. Provisional Application No. 60/168,699, filed Dec. 3, 1999.

### FIELD OF THE INVENTION

The present invention relates to a toggle action dispensing closure for dispensing a liquid or a semi-solid product from a container, and more particularly to a toggle action dispensing closure having locking means.

### DESCRIPTION OF THE RELATED ART

Current toggle action dispensing closures typically contain a cap having a base and a lid pivotally mounted to the base. The lid is movable from a closed position to an open position by pressing downward on one side of the lid, thereby pivoting the lid on the base, lifting the opposite side of the lid and exposing a discharge opening. The problem with such closures is that they can easily be manipulated to an open position by a child or by accident, resulting in potential harm or spillage.

U.S. Pat. No. 5,622,284 to Sawicki describes a child-resistant auxiliary control cap which overlies and is rotatable with respect to a toggle action closure cap. The control cap has a partial, sector-like top wall which covers only a portion of the closure cap and prevents one from opening the closure cap. The closure cap may be opened only by a probe acting through a restricted opening in the top wall of the control cap and then only when that wall overlies the press-to-open section of the closure cap. U.S. Pat. No. 5,622,284 is incorporated by reference herein in its entirety.

There is presently a need for an improved toggle action dispensing cap.

### BRIEF SUMMARY OF THE INVENTION

The present invention is a toggle action dispensing closure having a locking means. The closure includes a base, a lid mounted to the base, and a movable lug attached to the lid. The lug has a back-angled bottom face which engages the base preventing the lid from being moved from a closed position to an open position.

In one embodiment of the invention, the base includes a ridge which is engaged by the lug, locking the lid in a closed position. In another embodiment of the invention, the lug is integrally attached to the top of the lid and includes a downwardly extending portion which engages an abutment ledge of a cutaway portion of the base to lock the lid in a closed position. In a third embodiment of the invention, the lug is formed integrally with a sidewall of the lid and has a terminal end which engages an abutment ledge of a cutaway portion of the base to lock the lid in a closed position.

### BRIEF DESCRIPTION OF THE DRAWINGS

FIG. 1 is a perspective of a toggle action dispensing closure with locking means in accordance with the present invention;

FIG. 2 is an exploded perspective view of the two components comprising the closure;

FIG. 3 is a side elevational view of the closure with the cap shown prior to assembly;

FIG. 4 is a side elevational view similar to FIG. 3 showing the parts comprising the closure assembled in a closed position;

FIG. 5 is a transverse sectional view showing the closure in a closed position;

FIG. 5a is a detailed view of FIG. 5 taken from circular section 5a of FIG. 5;

FIG. 6 is a transverse sectional view showing the parts of the closure in an open position for dispensing product from the container;

FIG. 6a is a detailed view of FIG. 6 taken from circular section 6a of FIG. 6;

FIG. 7 is a top plan view of the closure lid;

FIG. 8 is a bottom plan view showing the closure lid;

FIG. 9 is a side elevational view showing the switch element;

FIG. 9a is an isometric bottom front view of the lid;

FIG. 9b is an isometric bottom rear view of the lid;

FIG. 10 is an enlarged side elevational view partly in section to show the switch in a locked position;

FIG. 10a is a detailed view taken from the circular section 10a of FIG. 10;

FIG. 11 is a side elevational view similar to FIG. 10, partially in sections to show the switch activated to a position to allow pivoting of the lid to an open position;

FIG. 12 shows the lid in a fully pivoted position, the switch locking arm in a displaced position;

FIG. 13 is a perspective view of another embodiment of closure system in accordance with the present invention;

FIG. 14 is an exploded perspective view of the lid and closure body;

FIGS. 15 and 16 are side elevational views showing the lid before assembly and assembled to the closure body;

FIGS. 17 and 18 are side elevational views partly in section showing the parts in a closed sealed position and in an opened position respectively;

FIG. 17a is a detailed view taken from the circular section 17a of FIG. 17;

FIG. 18a is a detailed view taken from the circular section 18a of FIG. 18;

FIG. 19 is a top plan view of the lid;

FIG. 20 is a bottom plan view of the lid;

FIGS. 21-23, inclusive, are sequential views showing the switch in a closed, activated and pivoted position, respectively.

FIG. 21a is a detailed view taken from the circular section 21a of FIG. 21;

FIGS. 24 and 25 are isometric side elevational views of a third embodiment of the invention showing the lid and closure body in a closed position and in an open position, respectively.

### DETAILED DESCRIPTION OF THE INVENTION

U.S. Provisional Application No. 60/168,699, filed Dec. 3, 1999 is incorporated by reference herein, in its entirety.

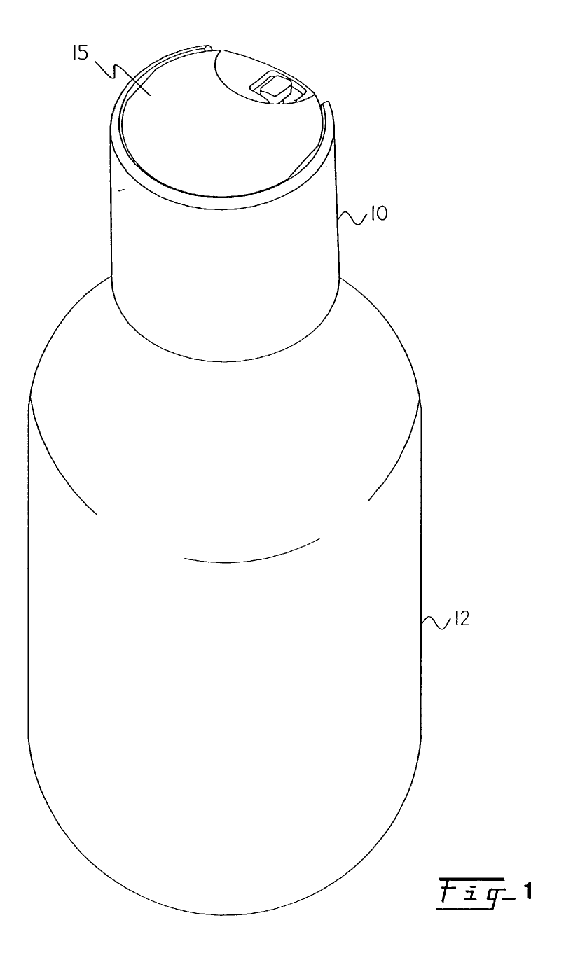

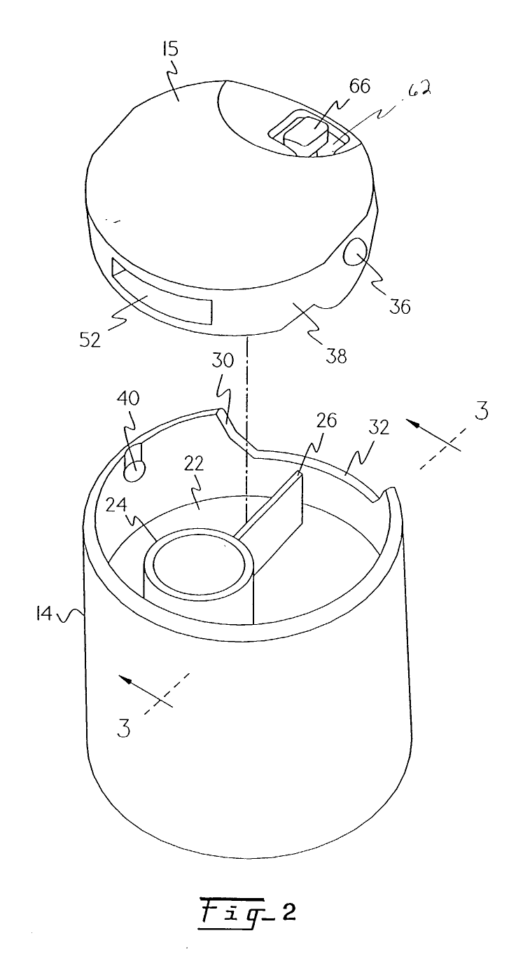

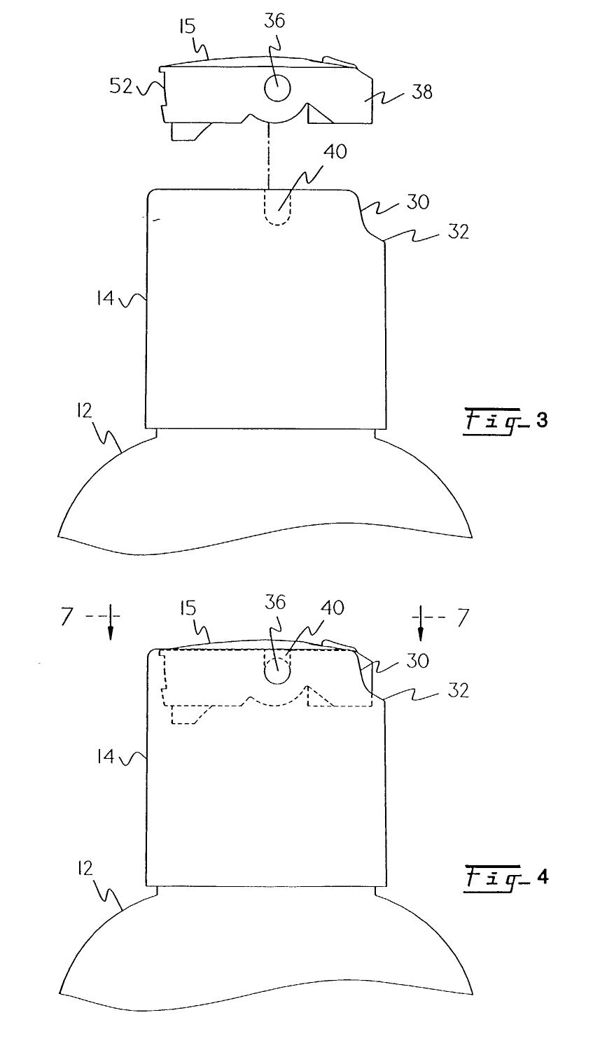

Referring now to the drawings and particularly to FIGS. 1 and 2 thereof, there is shown a closure assembly generally designated by the numeral 10 for controlling dispensing of product from a container such as a bottle 12.

The closure assembly comprises a closure body or base 14 and a cover cap or lid 15 pivotally mounted on the base 14 and operable between open and closed positions. Preferably, the base 14 is of generally cylindrical shape having internal spiral threads 16 which cooperatively engage with threads 18 on the container finish 20 so that the closure assembly may be selectively applied and removed from the container 12. The closure body 14 preferably has a transverse wall 22 spaced downwardly from its upper terminal end which has an upstanding discharge port 24 and a ridge 26 extending between the discharge port 24 and the interior sidewall of the closure body in the manner shown in FIG. 2. (Alternatively, the ridge may not extend the entire distance from the interior sidewall to the discharge port, but rather only a portion of the distance. Another alternative is for the ridge to be a cantilever extending from either the interior sidewall or the discharge port of the base.) The closure body or base 14 has a cutaway 30 defining an abutment ledge 32 to facilitate pivoting the lid to an open position and for a separate purpose and function to be described hereinafter.

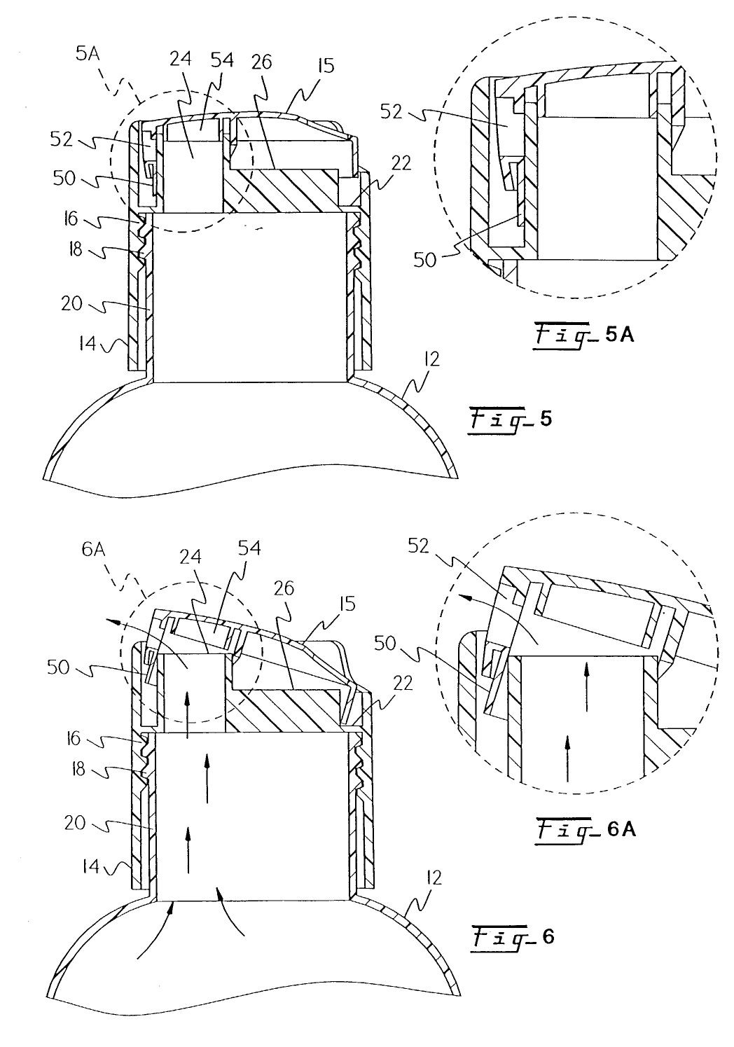

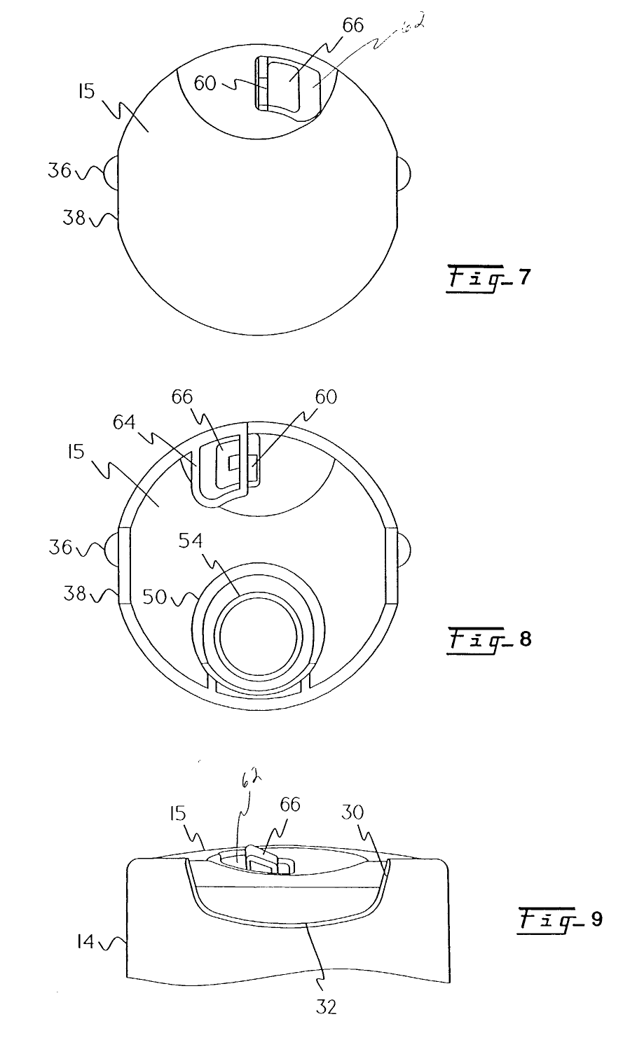

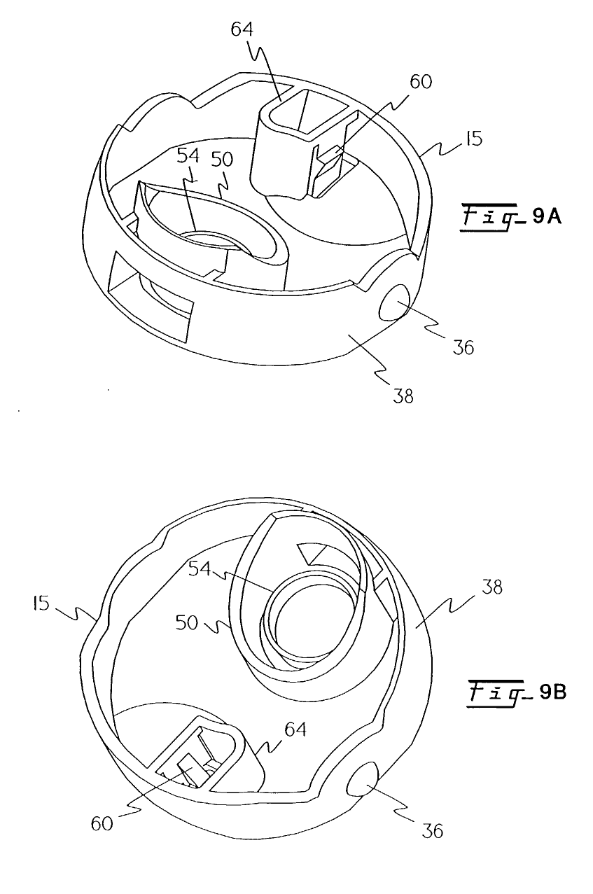

The cover cap or lid 15 is of generally disc-like form and is adapted to be pivotally mounted on the closure body or base 14 and to this end has a pair of diametrically opposed pivot projections 36 projecting radially from the sidewall 38 of the cover cap which engage in diametrically opposed recesses 40 in the closure body or base 14 to allow for pivoting movement to position the cover cap 15 in a closed position (FIG. 5) and in an open position (FIG. 6) to permit for discharge of contents from the container 12. (Alternatively, the projections may be on the base 14, and the recesses on the lid 15.) The lid 15 has a first depending, generally cylindrical projection 50 having a discharge opening 52. The discharge opening 52 extends through to an exterior sidewall 38 of the lid 15.

The lid 15 also has a smaller second depending, generally cylindrical projection 54 which depends from the inside of the lid 15 and seals with and overlies the discharge opening 24 in the closure body in the manner shown in FIG. 5. The first flange discharge opening 52 defines a nozzle when the lid 15 is activated to the open position as shown in FIG. 6 to permit discharge of contents from the container 12 in the manner shown by the arrows.

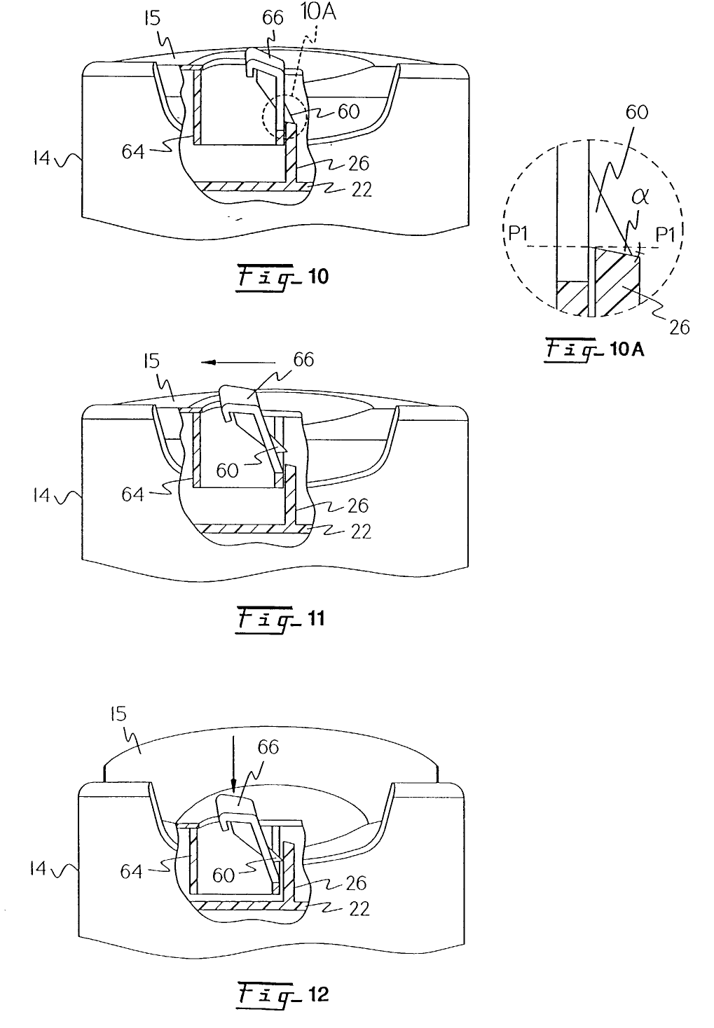

In one embodiment, the closure cap or lid 15 includes a lug 60 pivotally mounted on a support 64 depending from the rear edge of the lid 15 diametrically opposed from the discharge opening or nozzle 52, the lug 60 having a configuration which overlies and normally engages the top edge of the ridge 26 to secure the lid 15 in a closed position as shown in FIG. 10. The lug has a finger actuating portion 66 which protrudes through an opening 62 in the top of the lid 15 to facilitate pivoting the lug in a sideways direction to displace the terminal end of the lug 60 to one side of the ridge 26 whereby the lid 15 can be pivoted downwardly to raise it to an open position as shown in FIGS. 11 and 12.

The lug 60 has an back angled bottom face which creates an angle alpha (α) with plane P1-P1, as shown in FIG. 10A. The back angled bottom face of lug 60 mates with the ridge 26 having a back angled top face with the same angle alpha (α). (Alternatively, the ridge may lack a back angled top face and rather be thin and flexible to allow the lug to be pivoted in a sideways direction to displace the lug to one side of the ridge.) The mating angled faces of lug 60 and ridge 26 work in cooperation to prevent unintentional unlocking of lug 60; thereby, preventing unintentional discharge of container 12. The angle alpha (α) preferably has an acute range up to about 15°, but may be up to 30° or greater.

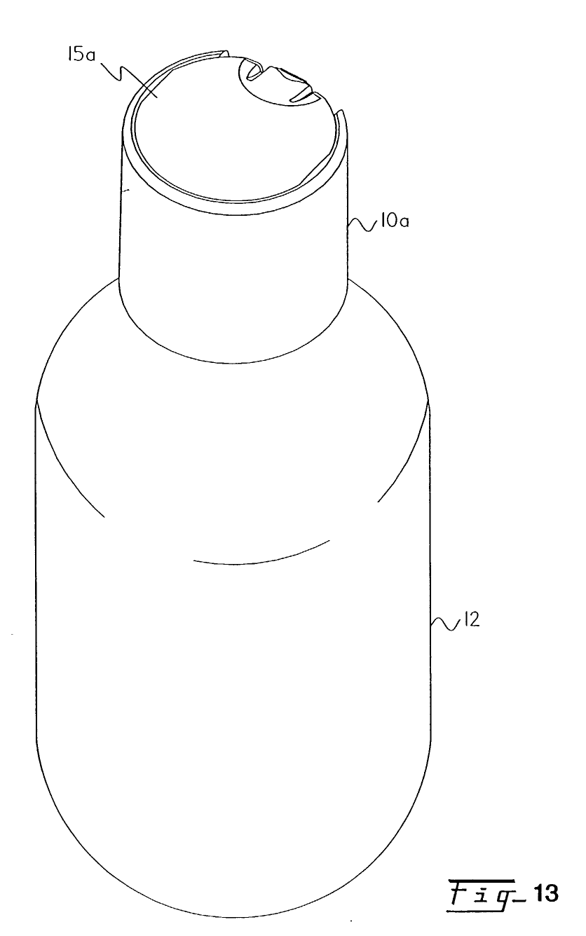

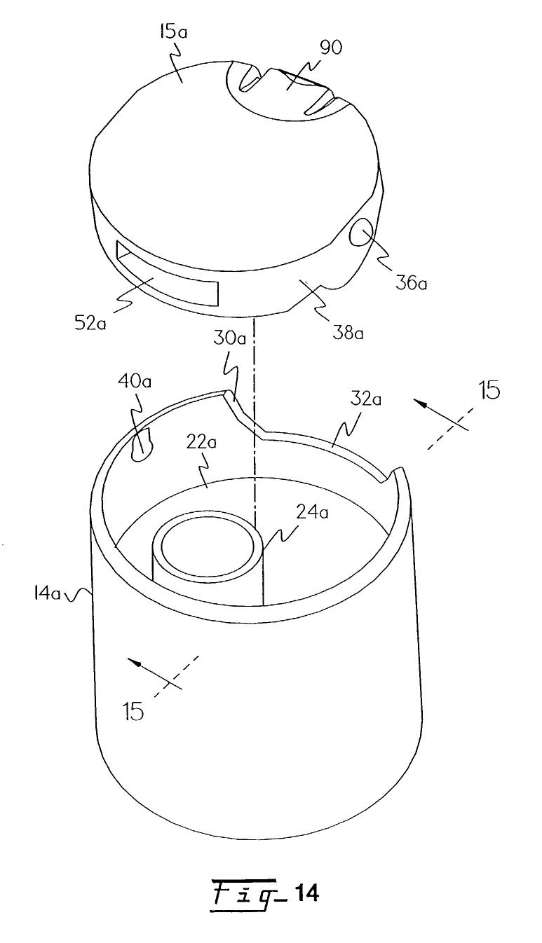

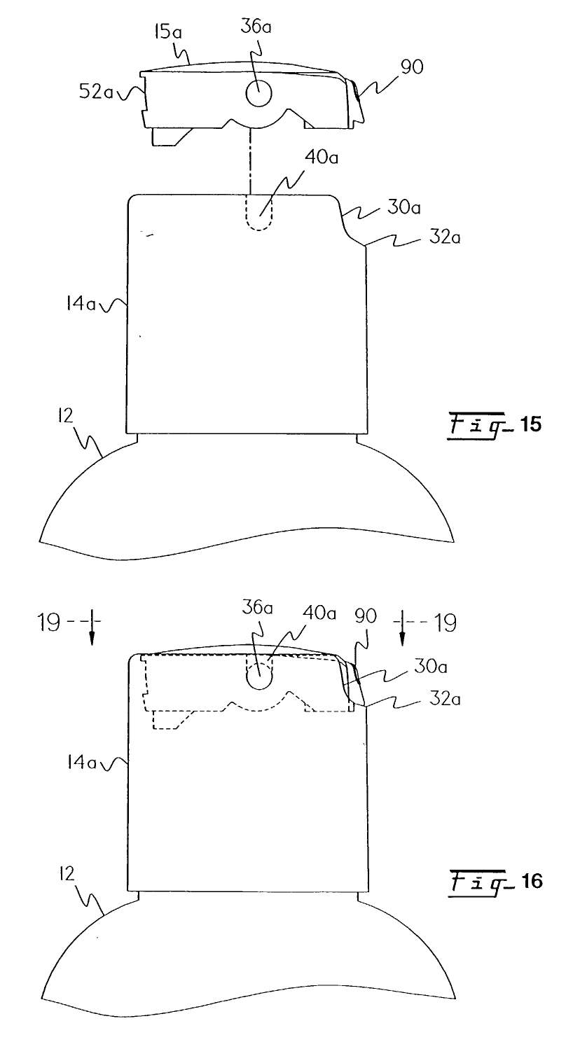

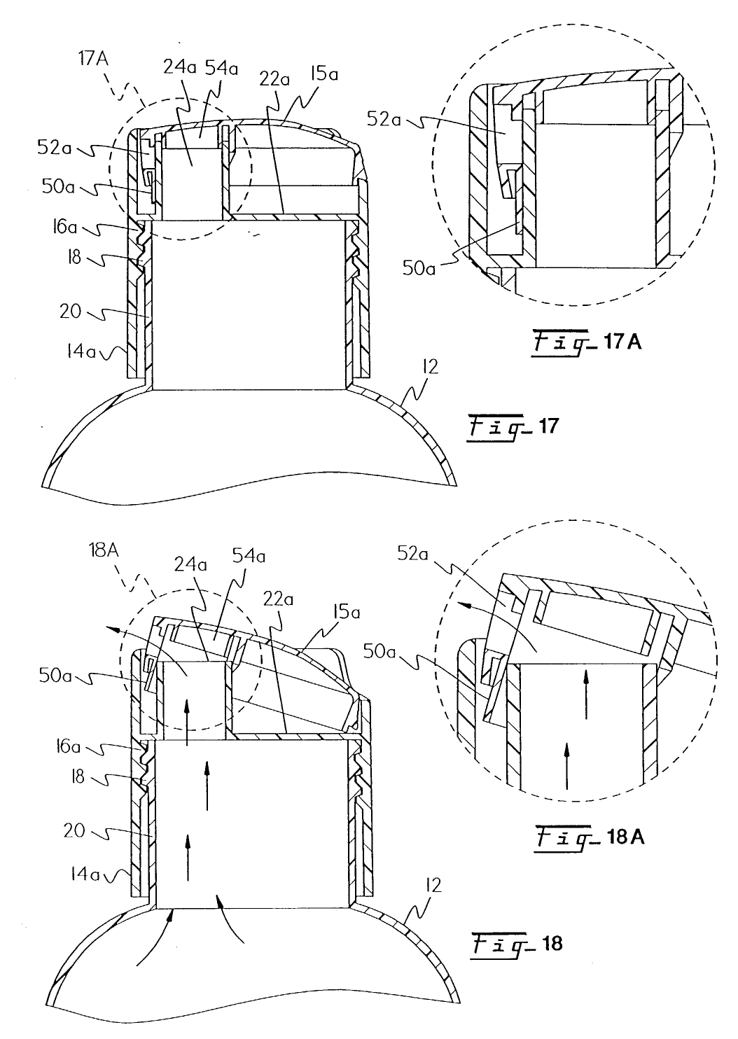

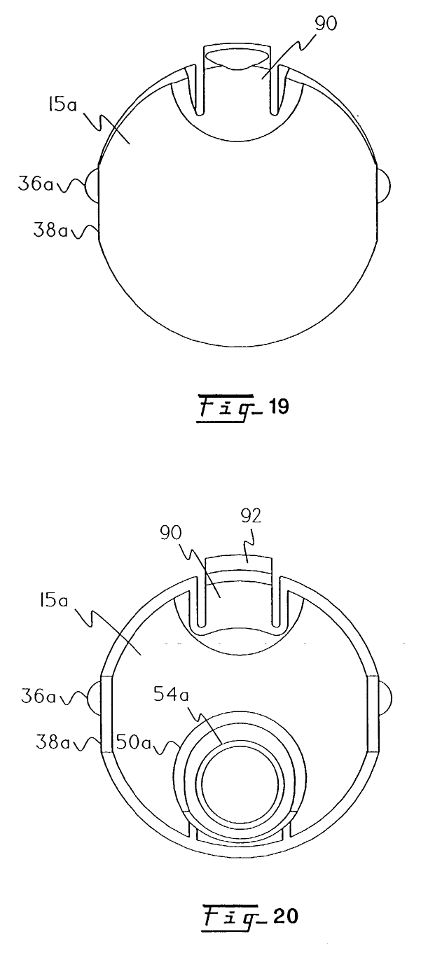

There is shown in FIGS. 13-23, inclusive, another embodiment of a closure assembly in accordance with the present invention. Parts which are generally the same as in the principal embodiment are designated with the same numeral with a subscript “a”. Thus, the assembly includes a closure body or base 14a which has threads 16a to assemble and remove it from the container 12 and a cover cap or lid 15a which is pivotally mounted between open and closed positions.

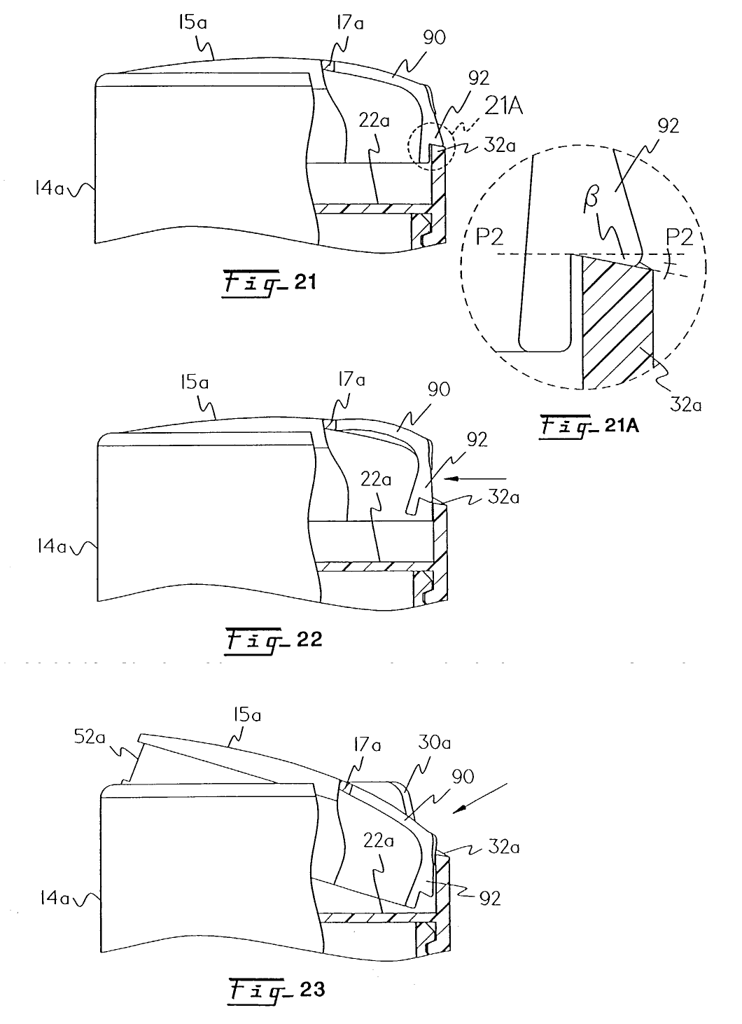

In the present instance, the lug arrangement for actuating the cover lid between open and closed positions is of a somewhat different configuration, and comprises a lug 90 formed integrally with the top 17a and has a downwardly extending portion 92 which engages the abutment edge 32a of the scalloped portion 30a to lock the parts in the closed position as shown in FIG. 21. The lug 90 may be pressed radially inwardly in the manner shown by the arrow in the FIG. 22 to displace it radially inwardly off of the abutment edge 32a, and whereby the lid 15a can be pivoted downwardly in the position shown in FIG. 23 to permit discharge of contents of the container 12.

The downwardly extending portion 92 of the lug 90 has an back angled bottom face which creates an angle beta (β) with plane P2-P2, as shown in FIG. 21A. The back angled bottom face of the downwardly extending portion 92 mates with abutment edge 32a having a back angled top face with the same angle beta (β). The mating angled faces of the downwardly extending portion 92 and abutment edge 32a work in cooperation to prevent unintentional unlocking of lug 90, and thereby, prevent unintentional discharge of container 12. The angle beta (β) preferably has an acute range up to about 15°, but may be up to 30° or greater.

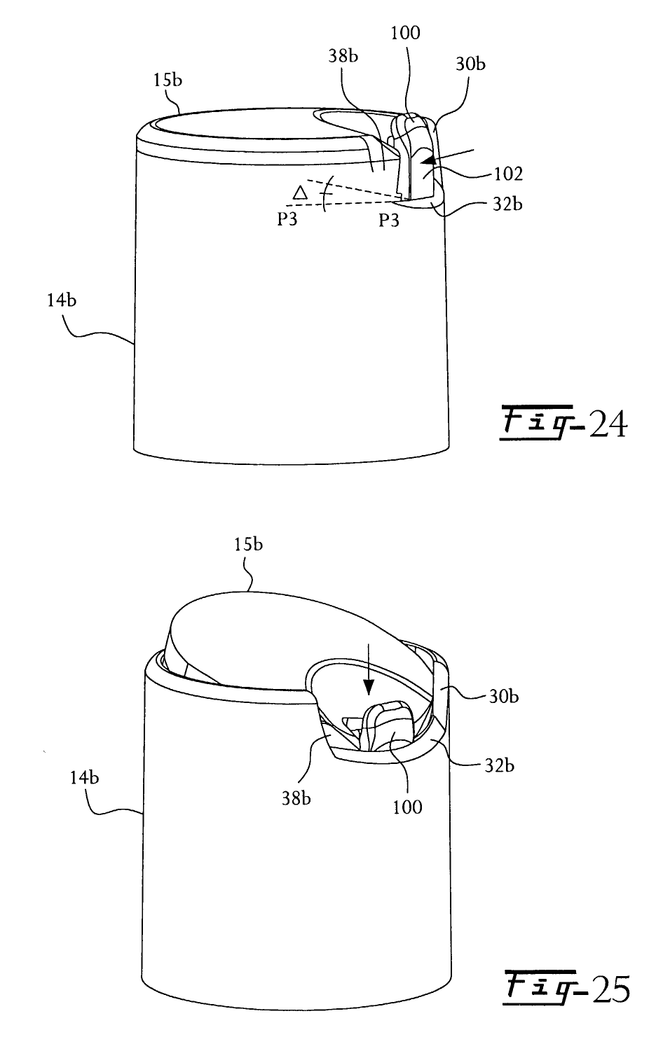

There is shown in FIG. 24 and FIG. 25 another embodiment of the closure assembly in accordance with the present invention. Parts which are generally the same as in the principal embodiment are designated with the same numeral with a subscript, “b”. Thus, the assembly includes a closure body or base 14b which is removably secured to container 12 (not shown) and a cover cap or lid 15b which is pivotally mounted between open and closed positions.

In the present instance, the lug arrangement for actuating the cover lid between open and closed positions is of a somewhat different configuration, and comprises a lug 100 formed integrally with the lower portion of sidewall 38b and has a terminal end 102 which engages the abutment edge 32b of the scalloped portion 30b to lock the parts in the closed position as shown in FIG. 24.

The lug 100 may be pressed radially inwardly in the manner shown by the arrow in the FIG. 24 to displace the terminal end 102 radially inwardly off of the abutment edge 32b and whereby the lid 15b can be pressed downwardly in the manner indicated by the arrow in FIG. 25 to pivot the lid 15b to an open position, thereby permitting discharge of the contents of the container 12. The terminal end 102 has an back angled bottom face which creates an angle delta (Δ) with plane P3-P3, as shown in FIG. 24. The back angled bottom face of the terminal end 102 mates with abutment edge 32b having a back angled top face with the same angle delta (Δ). The mating angled faces of terminal end 102 and abutment edge 32b work in cooperation to prevent unintentional unlocking of lug 100, and thereby prevents unintentional discharge of container 12 (not shown). The angle delta (Δ) preferably has an acute range up to about 15°, but may be up to 30° or greater.

Although the invention has been described in terms of exemplary embodiments, it is not limited thereto. Rather, the invention is to be construed broadly to cover other variants and embodiments, which can be practiced by those of ordinary skill in the art, within the scope and range of equivalents of the appended claims.

The exemplary embodiments provide benefits over the typical toggle action dispensing cap. By providing a means for locking the lid in a closed position, they are child-resistant and thereby reduce the likelihood of injury to or spillage by a child. They also reduce the likelihood of accidental movement to the open position and correspondingly, the possibility of spillage or drying of the container contents.

What is claimed is:

1. A dispensing closure cap, comprising:
a base,
a lid pivotally mounted on said base, and
a back-angled lug attached to the lid, wherein said lug is formed from the same piece of material as said lid, and wherein said lug has a first position in which said lug engages the base, preventing the lid from being moved from a closed position to an open position, and wherein said lug can be manually disengaged permitting the lid to be moved from the closed position to the open position.

2. The dispensing closure cap of claim 1, wherein the base includes a ridge, and wherein the lug engages the ridge to prevent movement of the lid to an open position.

3. The dispensing closure cap of claim 2, wherein the lug has a back-angled bottom face which mates with a back angled top face of the ridge to lock the closure cap in the closed position.

4. The dispensing closure cap of claim 3, wherein the angle from horizontal of the bottom face of the lug and the angle from horizontal of the top face of the ridge are substantially equal to a common angle between 0° and about 15°.

5. The dispensing closure cap of claim 2, wherein the base further comprises a discharge port, and wherein the lid further comprises a discharge opening, said discharge port and discharge opening permitting discharge of contents of a container, to which the closure cap is attached, when the lid is in the open position.

6. The dispensing closure cap of claim 5, wherein the discharge opening of the lid is located on a first depending projection extending from an inside of a top of the lid and extending through to an exterior side wall of the lid, and wherein the lid includes a second depending projection, the second depending projection smaller than the first depending projection and extending from the inside of the top of the lid and being within the first depending projection, and wherein said second depending projection seals with the discharge port of the base when the closure cap is in the closed position, and when the lid is moved to the open position, permits a passage to be formed between the discharge port of the base and the first depending projection of the lid.

7. The dispensing closure cap of claim 2, wherein the lug includes an actuating portion, said actuating portion allowing movement of the lug away from the ridge of the base when the actuating portion is pressed, thereby allowing the lid to be moved to the open position.

8. The dispensing closure cap of claim 2, wherein the lid further comprises a support to which the lug is mounted.

9. The dispensing closure cap of claim 5, wherein the lug is located at a rear edge of the lid diametrically opposed from the discharge opening of the lid.

10. The dispensing closure cap of claim 5, wherein the discharge port and the ridge of the base are located on a transverse wall of the base spaced downwardly from an upper terminal end of the base.

11. The dispensing closure cap of claim 2, wherein the base includes a cutaway portion on an upward terminal end of the base opposite the discharge opening of the lid.

12. The dispensing closure cap of claim 1, wherein the lid is pivotally mounted on the base through a pair of pivot projections which project from an exterior sidewall of the lid and engage a pair of recesses on an interior wall of the base.

13. A dispensing closure cap, comprising:
a base having a ridge and a discharge port, said ridge and port being located on a transverse wall of the base,
a lid mounted on the base, said lid having a closed position and an open position and a support, and
a lug attached to the lid, wherein said lug is formed from the same piece of material as said lid, and wherein said lug is capable of engaging the ridge of the base preventing the lid from being moved from the closed position to the open position, and wherein said lug is attached to the support of the lid,
and wherein the lug of the lid includes an actuating portion, said actuating portion allowing movement of the lug away from the ridge of the base and thereby permitting the lid to be moved to the open position, said actuating portion protruding through an opening in the top of the lid,
and wherein the ridge of the base has a back angled top face, and the lug has a back angled bottom face which mates with the back angled top face of the ridge, the angle from horizontal of said bottom face and said top face being substantially equal and being between 0° and about 15°,
and wherein the lid is pivotally mounted on the base through a pair of pivot projections which project from the exterior sidewall of the lid and engage a pair of recesses on an interior wall of the base.

14. A dispensing closure cap, comprising:
a base having a sidewall, said sidewall having a cutaway portion defining an abutment ledge,
a lid mounted on said base, the lid having a closed position and an open position,
and a movable lug attached to the lid, wherein said lug is formed from the same piece of material as said lid, and wherein said lug engages the abutment ledge of the base when the cap is in a closed position.

15. The dispensing closure cap of claim 14, wherein the lug is attached to the top of the lid and includes a downwardly extending portion which engages the abutment ledge of the base, locking the lid in the closed position and allowing for opening of the lid when the downwardly extending portion is pressed radially inwardly until it clears the abutment ledge.

16. The dispensing closure cap of claim 14, wherein the lug is attached to a lower portion of an exterior sidewall of the lid and wherein said lug engages the abutment ledge of the base, locking the lid in a closed position and allowing for opening of the lid when the lug is pressed radially inwardly until it clears the abutment ledge.

17. The dispensing closure cap of claim 14, wherein a lower terminal end of the lug has a back angled bottom face which mates with a back angled top face of the abutment ledge of the base to lock the closure cap in the closed position.

18. The dispensing closure cap of claim 17, wherein the angle from horizontal of the bottom face of the lug is equal to the angle from horizontal of the top face of the abutment ledge, and wherein said angle is between 0° and about 15°.

19. The dispensing closure cap of claim 14, wherein the base further comprises a discharge port, and wherein the lid further comprises a discharge opening, said discharge port and discharge opening permitting discharge of contents of a container, to which the closure cap is attached, when the lid is in the open position.

20. The dispensing closure cap of claim 19, wherein the discharge opening of the lid is located on a first depending projection extending from an inside of a top of the lid and extending through to an exterior side wall of the lid, and wherein the lid includes a second depending projection, the second depending projection smaller than the first depending projection and extending from the inside of the top of the lid and being within the first depending projection, and wherein said second depending projection seals with the discharge port of the base when the closure cap is in the closed position, and when the lid is moved to the open position, permits a passage to be formed between the discharge port of the base and the first depending projection of the lid.

21. The dispensing closure cap of claim 19, wherein the lug of the lid is located at a rear edge of the lid diametrically opposed from the discharge opening of the lid.

22. A dispensing closure assembly, comprising:
a container, and
a cap mounted on the container, the cap having a base, a lid mounted on said base, and a back-angled lug attached to the lid, wherein said lug is formed from the same piece of material as said lid, and wherein said lug engages the base preventing the lid from being moved from a closed position to an open position.
